(19) United States
(12) Patent Application Publication
(10) Pub. No.: US 2004/0149866 A1
(43) Pub. Date: Aug. 5, 2004

(54) Gaming machine support stand

(75) Inventors: Christiane Boucher, Verdun (CA); Roger Garceau, Pierrefonds (CA); Alain Grondines, Montreal (CA)

Correspondence Address: GRAY CARY WARE & FREIDENRICH LLP, 4365 EXECUTIVE DRIVE, SUITE 1100, SAN DIEGO, CA, 92121-2133, US

(73) Assignee: Societe des Loteries Video du Quebec, Montreal (CA)

(21) Appl. No.: 10/744,772

(22) Filed: Dec. 22, 2003

Related U.S. Application Data
(60) Provisional application No. 60/437,448, filed on Jan. 2, 2003.

(51) Int. Cl. F16M 11/00

(52) U.S. Cl. 248/127

(57) ABSTRACT

The present invention provides a gaming machine support stand with integrated adjustability enabling ergonomic comfort to be provided to a user of the gaming machine. The gaming machine support stand comprises a top and bottom that are interconnected by at least a front and back wall. The front wall of the stand has at least one ergonomic step associated therewith, providing players of the gaming machine interconnected to the support stand, a location at which they may rest one or more feet. The ergonomic step(s) may be adjustable in various planes thereby enabling the variation of the position thereof by an individual resulting in a more personal ergonomic positioning of the ergonomic step associated with gaming machine support stand. The back wall of the support stand includes a protective member that can prevent items from falling behind the support stand, for example when the stand is positioned within close proximity to a wall. The top of the support stand is designed to receive a gaming machine of the type commonly used and designed for the casino or lottery industry, and therefore the top has associated with it anchoring means provided in order to secure the gaming machine to the support stand.

### CROSS REFERENCE TO RELATED APPLICATION(S)

This application claims the benefit of priority under 35 U.S.C. § 119(e) of U.S. Ser. No. 60/437,448, filed Jan. 2, 2003, the entire content of which is incorporated herein by reference.

### BACKGROUND OF THE INVENTION

1. Field of the Invention

The present invention pertains to the field of stands and more specifically to gaming machine support stands.

2. Background Information

Gaming machines such as slot machines, automatic poker, or blackjack machines are commonly found in gambling casinos or video lottery establishments. The available floor space within the casino lottery establishments obviously dictates the number of gaming machines which may be placed therein. For example, Casinos are often found in commercial or business districts where floor space is valued at a premium price. Furthermore, because of fire and safety regulations which require certain minimum aisle space through casinos, such regulations also limit the number of gaming machines which may be placed within a specified floor area. Although casino managers have become quite adept in arranging gaming machines to optimize the use of available floor space, one major limiting factor which determines the number of gaming machines that can be placed in a specified floor area is the individual size of each of the gaming machines. Another limiting factor is how close a player can comfortably sit to a gaming machine. As would be readily apparent, increasing the number of gaming machines in a casino results directly in additional game playing which, in turn, results directly in higher revenues for the gaming establishment.

Ergonomics is a body of knowledge about human abilities, human limitations and other human characteristics that are relevant to design. Ergonomic design is the application of this body of knowledge to the design of tools, machines, systems, tasks, jobs, and environments for safe, comfortable and effective human use. The word “ergonomics” is often used synonymously with “human factors engineering.”

Many people view ergonomics as the science and applied science of fitting tasks and equipment to people, rather than forcing people to adapt to designs that neglect the unique capabilities and limitations of the human. Designs that consider human abilities often make human work more productive, efficient, reliable, and safe. These factors often translate into significant bottom-line competitive strategies for the companies that choose to implement ergonomic principles into the design and operation of their products.

The method in which a product is used defines whether that particular product is ergonomically designed. Thus, when designing a product one should have a particular use in mind before one can determine what design of the product will be the best “fit.” Determining the “fit” requires consideration of tasks to be performed with the product, including such things as the population of people that will interact with the product, and the physical and cognitive abilities required by the product and tasks. Therefore, a product may be ergonomically designed for a specific application by designing the product to match the characteristics of the required operations and the characteristics of the people that will be using the product.

Some products are designed to specifically reduce one or more commonly understood ergonomic risk factors. Ergonomic risk factors include such things as high forces, awkward postures, repetition, vibration, etc. For example, a tool that has been designed to reduce potentially harmful exposure to hand/arm vibration could be considered “ergonomically designed,” but only in terms of its vibration characteristics. If a worker is required to use that same tool in a stressful posture, due to a mismatch between the tool, worker, and the orientation of the point of tool operation, for instance, then that tool may no longer be considered “ergonomic” for that particular application.

Gaming machines such as slot machines and video lottery terminals typically have been designed in two distinct styles: a “slant-top” style and an “upright” style. “Slant-top” gaming machines include a mechanical or video display that is slanted at about a thirty degree angle toward a player and are designed to be played by a player in a seated position. Although the “slant-top” machines are fairly comfortable for use by a player in a seated position, the machines occupy a lot of valuable floor space in establishments such as casinos.

“Upright” gaming machines include a mechanical or video display that is oriented substantially vertical relative to a player and are designed to be played by a player in a standing position. Although the “upright” machines occupy less floor space than the “slant-top” machines, the “upright” machines are less comfortable to use than the “slant-top” machines because a player may be required to stand while playing the machine. In an effort to minimize discomfort, most establishments now provide stools for players to sit on while playing the “upright” machines.

Because the “upright” machines were originally designed to be played by a player in a standing position, a seated player often experiences discomfort while interacting with such features as the machine's button panel, card reader, and coin tray. First, the button panel is mounted at a height that requires an average seated player to awkwardly lift his or her forearms upwardly relative to the horizontal. Second, the card reader is typically mounted near the top of the machine above the machine's display. Players often carry their card on a string that hangs around their neck and leave the string around their neck even when the card has been inserted into the card reader. As a result, the string may awkwardly dangle over the machine's display as the player plays the gaming machine. Finally, the coin tray mounted below the button panel is typically located closer to a seated player than a front end of the button panel. Because this arrangement creates inadequate knee clearance, the player may bump his or her knee into the coin tray while attempting to interact with the button panel. The discomfort associated with the above-noted features of “upright” gaming machines is exacerbated by the fact that many players remain at the same machine and perform repetitious movements for long periods of time.

There are a number of gaming machine support stands that have been designed with a fixed foot rest or a support cabinet with a foot rest attached thereto. Other prior art support stands disclose gaming machines with integrated stands. U.S. Design Patents Nos. D472,939S, D451,148s and 6,334,612 disclose the various gaming machines support stands.

Therefore, there is a need for a stand that incorporates ergonomic features enabling better comfort to the participant during use of a gaming machine, while also providing features for enhancing fire safety, protection of cables and wiring, and security against tampering.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a gaming machine support stand. In accordance with an aspect of the present invention, there is provided a support stand for a gaming device, comprising: a housing having a top, bottom, front wall and back wall, said housing having a structural support system integrated therein; at least one ergonomic step associated with the front wall for providing a means for a user of the gaming machine rest in an ergonomic orientation; and a protective member associated with the back wall; wherein said front and back walls interconnect said top and bottom of the support stand.

### BRIEF DESCRIPTION OF THE DRAWINGS

FIG. 1 is a perspective view of the support stand according to one embodiment of the present invention.

FIG. 2 is another perspective view of the support stand according to one embodiment of the present invention.

FIG. 3 is a perspective view of a gaming machine cabinet commonly used in the gaming industry.

FIG. 4 is an exploded view of a support stand according to one embodiment of the present invention.

### DETAILED DESCRIPTION OF THE INVENTION

Definitions

The term “gaming machine” is used to define any unit that enables a user to play a game, for example a video lottery game, slot machine or any other type of mechanical or video machine commonly known in the casino or lottery type industry. For example a slot machine may have virtual or real rotating wheels wherein upon the display of predetermined images on said wheels the user wins a prize.

The term “wall” is used to define a substantially vertical structure, which need not be flat and which may have protruding or recessed portions.

Unless defined otherwise, all technical and scientific terms used herein have the same meaning as commonly understood by one of ordinary skill in the art to which this invention belongs.

The present invention provides a gaming machine support stand with integrated adjustability enabling ergonomic comfort to be provided to a user of the gaming machine. The gaming machine support stand comprises a top and bottom that are interconnected by at least a front and back wall. The front wall of the stand has at least one ergonomic step associated therewith, providing players of the gaming machine interconnected to the support stand, a location at which they may rest one or more feet, for example. In one embodiment, the ergonomic step(s) may be adjustable in various planes thereby enabling the variation of the position thereof by an individual resulting in a more personal ergonomic positioning of the ergonomic step associated with gaming machine support stand. The back wall of the support stand includes a protective member that can prevent items from falling behind the support stand, for example when the stand is positioned within close proximity to a wall. The top of the support stand is designed to receive a gaming machine of the type commonly used and designed for the casino or lottery industry, and therefore the top has associated with it anchoring means provided in order to secure the gaming machine to the support stand.

In one embodiment, a support shelf for various items is strategically positioned and connected to the top of the support stand in addition to this support shelf being adjustable as desired by a user. In addition, associated with the bottom of the support stand is a support mechanism that enables the support stand to be positioned in a desired orientation, for example in an orientation such that the top of the support stand is level independent of the level of the floor surface.

The design of this device provides flexibility for adjustment with respect to ergonomics. In particular, the numerous adjustable components of the support stand provides an individual, whether seated or standing in front of the support stand, greater ergonomic comfort and convenience. This is an important benefit for casinos and lottery type establishments, as it would allow players to play the gaming machines for longer periods of time and reduce the fatigue that can be associated with poor ergonomic design, for example.

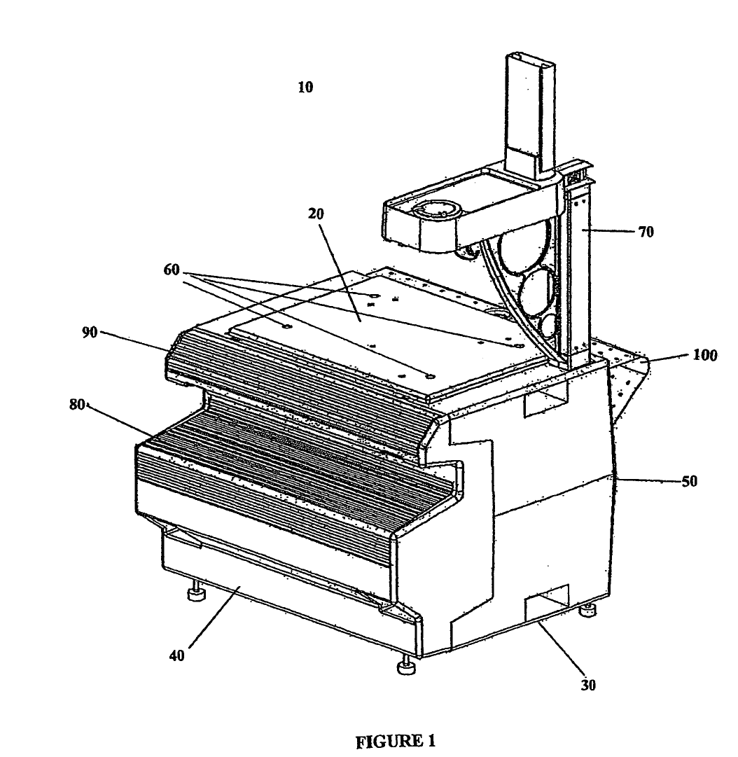

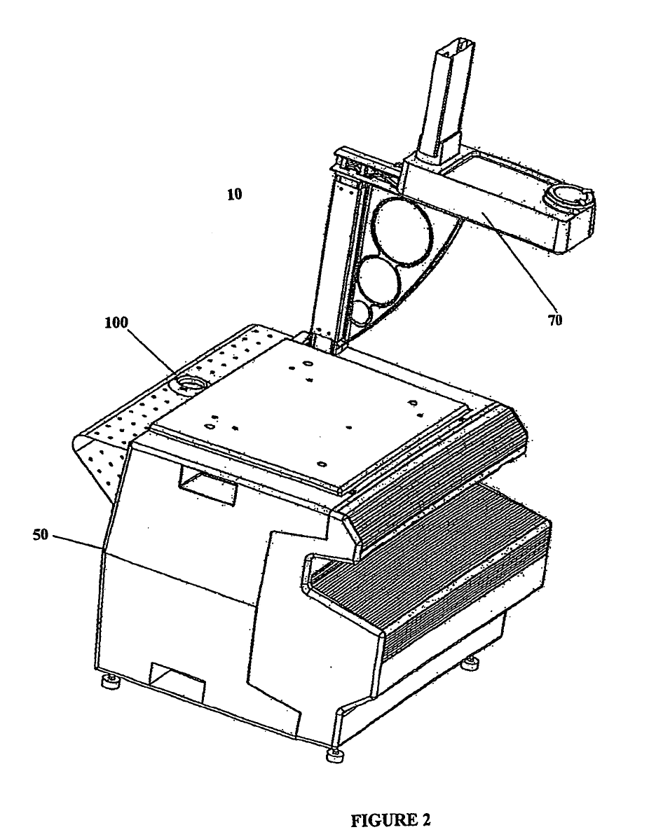

FIGS. 1 and 2 illustrate a perspective view of the gaming machine support stand according to one embodiment of the present invention. The gaming machine support stand 10 includes a top 20, a bottom 30, a front wall 40, a back wall 50, anchoring means 60, a support shelf 70, one or more ergonomic steps 80 and 90, and a protective member 100.

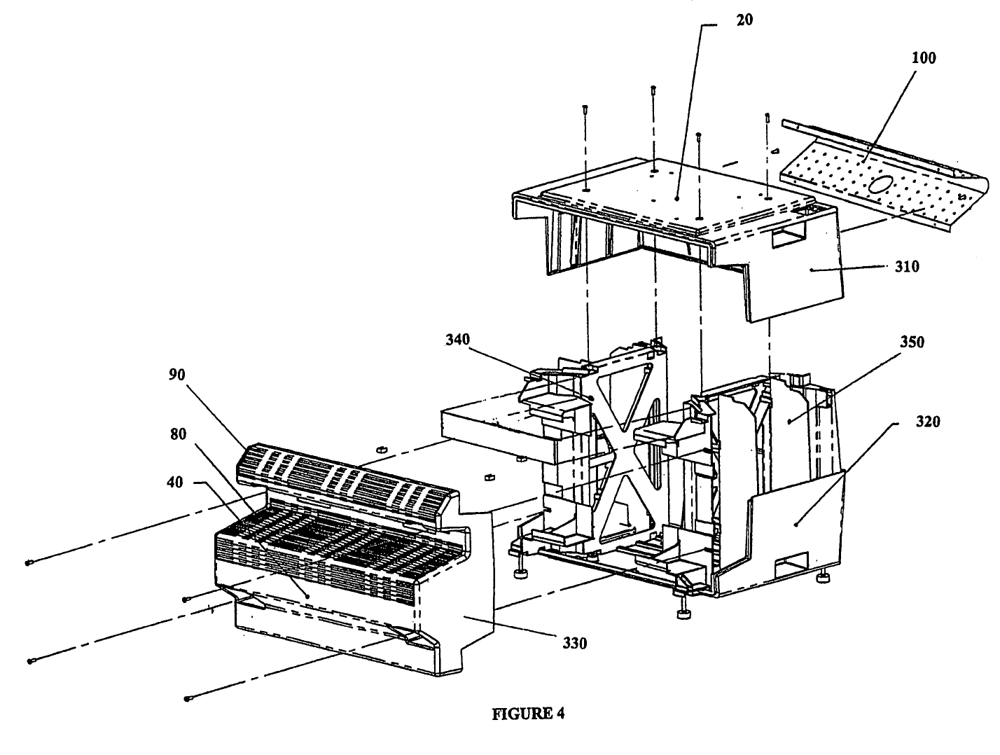

In one embodiment of the present invention, and as illustrated in FIG. 4, the body of the gaming machine support stand can be fabricated from three shell like components: an upper component 310, a lower component 320 and a front component 330. As such, the top of the stand 20 is provided by the upper component 310. The bottom of the stand is provided by the lower component 320. The back of the stand is provided partly by each the upper component 310 and the bottom component 320. The sides of the stand are provided partly by the upper component 310, partly by the bottom component 320 and partly by the front component 330. The front of the stand 40 is provided by the front component 330. In this embodiment of the present invention, the stand contains an internal supporting structure comprising a left portion 340 and right portion 350, wherein these two portions are mirror images of each other and are attached to the lower component using bolts or other attachment means known to a worker skilled in the art. In this embodiment of the present invention, the front component of the support stand can be removed and/or replaced without the need for removing the gaming machine. In this manner different configuration of an ergonomic step can be interchanged or a worn or broken ergonomic step that is associated with the front component can be replaced in an easy manner.

Front Wall and Ergonomic Step(s)

There is associated with the front wall of the support stand one or more ergonomic steps 80 which enable an individual playing the gaming machine positioned on the support stand 10 to rest one or both feet.

In one embodiment of the present invention, the front wall is associated with an adjustable ergonomic step. The adjustable ergonomic step provides a means to axially rotate the step around its horizontal axis. In one embodiment, the adjustable step is pivotally connected to the front wall; for example, an ergonomic step may be mounted on an axle that is laterally mounted across the front wall such that the step can freely rotate around the axle. Optionally, this axle can be adjusted to a variety of rotational positions, such that once in a particular position, the axle is locked in the desired orientation. In another embodiment, the pivotal connections are retaining pins.

The ergonomic step may additionally be adjustable in the vertical direction, thereby enabling the adjustment of the height thereof in order to accommodate a variety of heights of individuals that use the gaming machine in addition to standing or sitting players. The vertical movement of the step can be provided by a vertical screw type mechanism interconnected with the step, wherein rotation of the screw can move the step up or down. Optionally, the step can be slidably connected to the front wall of the support stand, wherein once the step is placed in a desired position, it can be locked there for use by the individual.

In another embodiment of the present invention, the front wall is designed with means to accept an interchangeable step. The interchangeable step can be mounted at different heights and at varying angles on the front wall. The interchangeable step further provides flexibility, for example, to mount additional steps. In one embodiment the entire front wall together with at least one ergonomic step can be interchanged.

The one or more ergonomic steps may include a covering or integrated system which resists the slipping of the user's feet. This may be provided by incorporating a surface which has a high frictional coefficient, which may be a series of ridges in one or more directions, or a “sand paper”-like coarse surface or any other type of friction enhancement means as would be known to a worker skilled in the art.

In an embodiment of the present invention, the front of the stand can be removed with the gaming machine still interconnected to the top 20. This feature permits quick and efficient replacement of a damaged front wall or worn-out anti-slipping surface.

In another embodiment of the present invention, as shown in FIG. 4, the front shell component 330 can be removed from the rest of the gaming support stand while a gaming machine is still interconnected to the top 20. Since the front wall 40 is a part of the front shell component 330, one can quickly and easily replace of the front wall 40, the foot support(s) 80 and 90, or the anti-slipping surface simply by detaching and replacing the front component.

In another embodiment, a variety of interchangeable front components can be produced each providing a different configuration for the positions and orientations of the foot supports. Thus, ergonomic configurations can be altered simply by switching one front component for another, while the gaming machine is still interconnected to the top of the gaming machine support stand.

Back Wall and Protective Member

In one embodiment of the present invention and with reference to FIG. 2, the support stand has a protective member 100 which may prevent items from falling behind the support stand when positioned or pushed proximate to a wall, for example. The protective member 100 may also serve to maintain a predetermined distance between the stand 10 and electrical outlets in a wall. As such the outlets and the electrical wire from the gaming machine connected into the outlet may be protected when the stand 10 is proximate to the wall. The protective member 100 may also assure a safe distance between the stand 10 and any electrical heating baseboard or vent system which may be within the wall, for example.

Additionally, the protective member may serve to provide a form of “wire management”. For example, in casinos or lottery type establishments where gaming machines are serially placed and connected in a row, wires such as electrical and computer/network data cables may be routed into an opening at the top of the protective member and passed along the interior of the protective member for serial connections with adjacent gaming machines. In such a configuration, the computer/network data cable connections between each gaming machine will be enclosed within the protective member thereby limiting the risk of outside tampering and thus providing the additional benefit of enhanced security.

The vertical positioning of the protective member 100 on the back wall 50 of the support stand may be arbitrary; however, it may be determined based on the intended functionality of said protective member and the physical restrictions of the location at which the gaming machine and support stand are to be positioned. For example, the protective member may be located above electrical outlets to prevent patrons from disconnecting a gaming machine. The shape of the protective member 100 may be rectangular, circular, triangular, trapezoidal or any other shape as would be known by a worker skilled in the relevant art. The material used for the protective member 100 may be a hardened resin or fibreglass, steel, aluminium or any other material that would be known by a worker skilled in the relevant art. The type of material and the cross sectional shape of the protective member are directly related to its structural strength and therefore these aspects are to be considered in the design thereof. The protective member may additionally have a bore or hole therein which can provide a location for the electrical cord(s) of the gaming machine to be positioned and therefore not pinched against a wall, for example.

Top and Anchoring Means

With reference to FIG. 1, the top 20 is used to provide support for a gaming machine. In one embodiment of the present invention, the top 20 includes anchoring means 60 that are optimally distributed to securely interconnect a gaming machine thereto. The anchoring positions can be, for example, bores 60 located proximate to the outer edge of the top. Restraining devices may be inserted into the bores 60 enabling the fastening of a gaming machine to the support stand. In one embodiment, the bores 60 may be threaded thereby enabling the mechanical interconnection between the bores and the restraining devices that can be, for example, appropriately sized and threaded bolts. In an alternate embodiment, the bores provide a location into which restraining devices may be inserted and subsequently fastened. For example, a nut can be connected to a bolt, thereby securing the gaming machine to the support stand. In this alternate embodiment, the bores may not be threaded, however they must have a diameter that is larger than the diameter of the restraining devices being used. In this alternate example a variety of different bolts, washers and/or lock washers may be used as the restraining devices, as would be known to a worker skilled in the art. Alternate restraining devices may be used to interconnect a gaming machine to the support stand, for example screws, rivets, pins or any other type of device as would be known to a worker skilled in the art. The type of restraining devices that are used can directly determine the type of anchoring means to be associated with the top end of the support stand, for example.

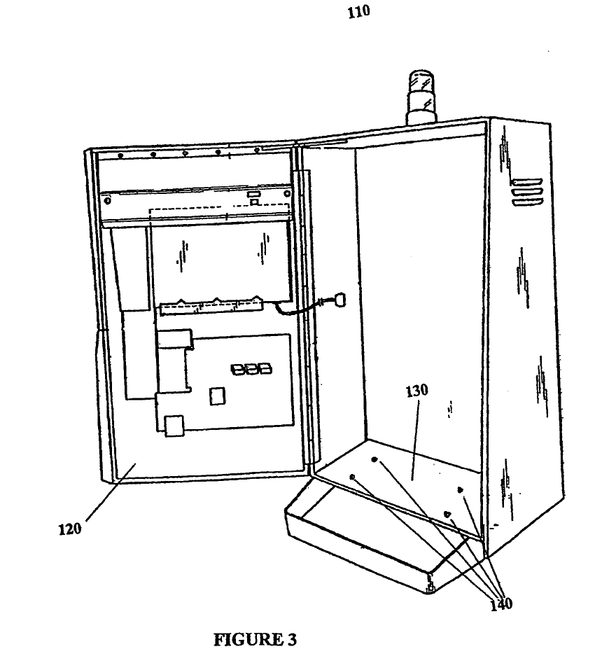

In one embodiment and with reference to FIG. 3, a cabinet 110 of a commonly used gaming machine is shown. A door 120 is moveable between a first open position as illustrated and a second, closed position. While the door 120 is in an opened orientation, the interior of the gaming machine is accessible. The bottom end 130 of the interior includes apertures 140 that correspond in location to the anchoring positions associated with the top of the support stand, thereby enabling the insertion of restraining devices and the subsequent anchoring of the gaming machine on the support stand of the present invention. In one example, the use of bolts that are passed through the apertures of the cabinet and then threaded into the top end of the stand enables a quick and easy method of removing and securing a gaming machine to the support stand of the present invention. The location and number of apertures may vary and the stand of the present invention can be modified to incorporate an appropriately located anchoring positions in the top of the support stand, thereby enabling various types of gaming machines to be fastened to the support stand.

Bottom End and Support Means

The support mechanisms associated with the bottom end of the support stand provide a means for adjusting the orientation of the support stand and the top end thereof. In this manner the top end can be oriented in a level configuration independent of the levelness of the floor. In one embodiment, the support mechanisms comprise a threaded shaft having rubber ends thereby enabling the adjustment of their length and resisting movement on the floor, respectively. In this manner the support stand can be positioned on a variety of uneven surfaces and the support mechanisms provide a means for levelling and stabilising the support stand. Other forms of the shaft of the support mechanisms may be envisioned as would be known to a worker skilled in the art. For example, the shaft may have notches along its length and a spring loaded locking mechanism associated with the bottom end of the support stand that would interconnect with a desired notch.

Support Structure

As would be understood by a worker skilled in the art, the support stand must have sufficient structural strength in order to support itself and the weight of the gaming machine attached thereto and in many cases a factor of safety is integrated into the design of the support structure associated with this form of support stand. In one embodiment, this structural strength is provided by a framing system on the interior of the support stand and to which the top, bottom and the front and back walls are connected. In an alternate embodiment, the structural strength of the support stand is provided by an adjustable framing system, for example, a ratcheting cross-member assembly in the interior of the support stand in which the top, bottom and the front and back walls are interconnected. The ratcheting cross-member assembly increases or decreases the overall length of the cross-member assembly allowing the height of the top end to be raised or lowered to a desired height, for example.

In an alternate embodiment, the top, bottom and the front and back walls can be designed such that they each have an integrated structural system which can, for example, be provided by the cross sectional design of the sections. In addition, side walls can be added to further reinforce the support stand and to provide additional rigidity and/or stability thereto.

Side Walls

In one embodiment, the gaming machine support stand may be constructed such that it has two side walls. In one embodiment, the side walls are made to be substantially vertical, parallel to each other, and perpendicular to the top. As such, adjacent gaming machine support stands could be placed tightly against each other to avoid leaving substantial gaps between them. Such close placement could reduce the possibility of objects falling between the gaps. For example, the danger of cigarettes falling into the gap between two support stands and starting a fire could be reduced.

Support Shelf

A support shelf 70 is also interconnected to the top 20 of the support stand 10. The support shelf can take on a variety of configurations and may additionally be rotatable and adjustable in both vertical and horizontal directions, thereby enabling the movement of the support shelf to a preferred position of the user, for example.

In one embodiment and with further reference to FIG. 2, the support shelf 70 enables a player to deposit their beverage container or other items when playing a gaming machine connected to the support stand 10 of the present invention. Examples of other items which may be deposited on the support stand include beverage containers, coin holders, bowls, plates, ashtrays or other items commonly found in casinos or other gaming establishments. The support shelf may be moved vertically, horizontally and/or may be rotated thereby enabling a user to position the support shelf in a location that is more desirable for them, if required. The support shelf 70 may optionally be removed from the support stand 10 in order to increase the surface area on the top 20. The interconnection location between the support shelf 70 and the top may be concealed by a cover.

Alternately, the support shelf 70 can be slideably interconnected to the top of the support stand enabling the shelf to be moved either forward or backwards on the top 20 of the support stand 10. Such a movable shelf 70 enables an individual using the gaming machine on the support stand, greater access to the gaming machine while still having his or her beverage positioned on the shelf, for example.

Secure Attachment Means

In an embodiment of the present invention, secure attachment means are used to prevent unauthorised persons detaching any part of the gaming support stand. In an embodiment, the secure attachment means comprise bolts or screws having non-standard specially designed heads such that they can only be turned using a special tool.

In another embodiment, as shown in FIG. 4, the gaming support stand includes a shell assembled from three shell components, wherein the shell components are attached using secure attachment means to prevent unauthorised persons from detaching a component. In an embodiment, as shown in FIG. 4, the secure attachment means are used to prevent unauthorised access to the space inside the support stand.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A support stand for a gaming device, comprising:
a) a housing having a top, bottom, front wall and back wall, said housing having a structural support system integrated therein;
b) at least one ergonomic step associated with the front wall for providing a means for a user of the gaming machine rest in an ergonomic orientation; and
c) a protective member associated with the back wall;
wherein said front and back walls interconnect said top and bottom of the support stand.

2. The support stand according to claim 1 wherein said housing has side walls and comprises:
a) an upper component providing the top of the housing, part of the back wall, and part of the side walls;
b) a lower component providing the bottom of the housing, part of the back wall, and part of the side walls; and
c) a front component providing the front wall of the housing, and part of the side walls

3. The support stand according to claim 2 wherein said front component can be removed while a gaming machine is still interconnected to said top.

4. The support stand according to claim 1 wherein said ergonomic step is adjustable.

5. The support stand according to claim 1 wherein said ergonomic step is interchangeable.

6. The support stand according to claim 1 wherein said ergonomic step includes a friction enhancing surface; said friction enhancing surface includes a ridged surface or a coating with a material with a high frictional coefficient and said friction enhancing surface has a high abrasion resistance.

7. The support stand according to claim 1 wherein said protective member includes means for wire management; said means for wire management including an opening at the top of the protective member enabling passage of electrical or data cables from said gaming device to an interior region of said protective member.

8. The support stand according to claim 1 wherein said protective member is made of hardened resin, plastic, fibreglass, steel or aluminium.

9. The support stand according to claim 1 wherein said housing is made of metal, plastic or fiberglass.

10. The support stand according to claim 1 wherein said housing is made of a composite material composed of mineral substances selected from bauxite, quartz and fibreglass, said composite material further comprising a binding agent.

11. The support stand according to claim 1 wherein structural support is provided by a framing system located in the interior of said support stand.

12. The support stand according to claim 11 wherein said framing system is adjustable enabling said top to be raised or lowered.

13. The support stand according to claim 1 wherein structural support is provided by said top, bottom, front wall and back wall.

14. The support stand according to claim 1 wherein said housing has side walls that are substantially vertical and perpendicular to the top surface.

15. The support stand according to claim 14 wherein said walls are secured with specialised retaining devices that prevent unauthorized access to the inside of the stand.

16. The support stand according to claim 1 wherein said front wall can be removed while a gaming machine is interconnected to said top.

17. The support stand according to claim 1 wherein said top includes anchoring means enabling interconnection between said gaming device and said top.

18. The support stand according to claim 1 wherein a support shelf is operatively connected to said top.

19. The support stand according to claim 18 wherein said support shelf is removable.

20. The support stand according to claim 18 wherein said support shelf includes an adjustment assembly; said adjustment assembly providing means to rotate, raise and lower, and/or move horizontally said support shelf.

21. The support stand according to claim 8 wherein said support shelf includes means for removably securing a container.

22. The support stand according to claim 1 wherein said bottom includes levelling means for adjusting the orientation support stand, thereby enabling the levelling of the top.
